(19) United States
(12) Patent Application Publication
(10) Pub. No.: US 2008/0233382 A1
(43) Pub. Date: Sep. 25, 2008

(54) Nonwoven Fibrous Structure Comprising Compressed Sites and Molded Elements

(76) Inventors: Jared Dean Simmons, Cincinnati, OH (US); Michael Sean Pratt, Saint Bernard, OH (US); Jeffrey James Stechschulte, Cincinnati, OH (US); Astrid Annette Sheehan, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/050,983

(22) Filed: Mar. 19, 2008

Related U.S. Application Data
(60) Provisional application No. 60/918,876, filed on Mar. 19, 2007.

(51) Int. Cl. B32B 3/26; B29C 43/22

(52) U.S. Cl. 428/313.3; 264/517

(57) ABSTRACT

A nonwoven fibrous structure comprising compressed sites and molded elements. The combination of compressed sites and molded elements may provide for a fibrous structure comprising structural integrity in use, dispersability when flushed, and assistance to the user in cleansing.

### CROSS REFERENCE TO RELATED APPLICATION

This application claims the benefit of U.S. Provisional Application No. 60/918,876, filed Mar. 19, 2007, the substance of which is incorporated herein by reference.

### FIELD OF THE INVENTION

A nonwoven fibrous structure comprising compressed sites and molded elements. The combination of compressed sites and molded elements may provide for a fibrous structure comprising structural integrity in use, dispersability when flushed, and assistance to the user in cleansing.

### BACKGROUND OF THE INVENTION

Historically, various types of nonwoven fibrous structures have been utilized as disposable substrates. The various types of nonwovens used may differ in visual and tactile properties, usually due to the particular production processes used in their manufacture. In all cases, however, consumers of disposable substrates suitable for use as wipes, such as baby wipes, demand strength, thickness, flexibility, texture and softness in addition to other functional attributes such as cleaning ability.

Disposable substrates, such as wipes, may be disposed of by flushing them down a conventional toilet into a sewage or septic system where they may subsequently degrade. This disposal method may be both convenient and discrete for the user. It is desirable, however, that the substrate, once flushed, readily disperses or breaks apart so that it can pass through a conventional toilet and plumbing system without creating blockages. It is desirable that the substrate possess adequate structural integrity during its intended use, yet breaks apart when flushed. Compressed sites may provide for the ability of the substrate to break apart when flushed.

The characteristics of strength, thickness, flexibility, cleansing efficacy and texture impression may be affected by any hydromolding (also known as hydroembossing, hydraulic needlepunching, etc.) of the nonwoven fibrous structure during manufacture. The fibrous structure may be conveyed over a molding member, such as a drum or belt, that may comprise a molding pattern of raised areas, lowered areas, or combinations thereof interspersed thereon. The resulting image, graphic, or texture on the fibrous structure may be a molded element of the fibrous structure.

It is desirable to provide a nonwoven fibrous structure comprising a combination of compressed sites and molded elements. It would be desirable to provide a nonwoven fibrous structure comprising a balance between dispersability, structural integrity and assistance to the user in cleansing. It would be desirable to provide a method for the manufacture of such a nonwoven fibrous structure.

### SUMMARY OF THE INVENTION

A nonwoven fibrous structure comprising at least one compressed site and at least one molded element. The molded element may be hollow. The fibrous structure may comprise a plurality of compressed sites and the plurality of compressed sites may form a line of weakness. The fibrous structure may at least partially fail along the line of weakness.

A plurality of compressed sites may form a pattern, such as a geometric shape. The molded element may comprise a size-radius. The size-radius of the molded element may be larger than, smaller than or similar in size to the pattern of the compressed sites.

A process for making a nonwoven fibrous structure comprising at least one compressed site and at least one molded element may comprise the steps of conveying a fibrous web over a molding member, hydromolding the web and applying a compressive stress to the web. In an embodiment, the compressive stress may be applied subsequent to the hydromolding.

### BRIEF DESCRIPTION OF THE DRAWINGS

FIG. 1A is a view of an embodiment of a pattern of compressed sites.

FIG. 1B is an expanded view of a pattern of compressed sites in a geometric shape.

FIG. 2A is a view of an embodiment of an alternate pattern of compressed sites.

FIG. 2B is an expanded view of a pattern of compressed sites in a geometric shape.

FIG. 3 is a view of an embodiment of a fibrous structure comprising at least one compressed site and at least one molded element.

FIG. 4 is a view of an embodiment of a fibrous structure comprising at least one compressed site and at least one molded element.

FIG. 5 is a view of an embodiment of a fibrous structure comprising at least one compressed site and at least one molded element.

FIG. 6 is a view of an embodiment of a fibrous structure comprising at least one compressed site and at least one molded element.

FIG. 7 is a view of an embodiment of a fibrous structure comprising at least one compressed site and at least one molded element.

FIG. 8 is a side view of a molding member.

FIG. 9 is a top view of a molding member shown with a fibrous structure conveyed over the top of the molding member.

### DETAILED DESCRIPTION OF THE INVENTION

“Basis weight” refers herein to the weight (measured in grams) of a unit area (typically measured in square meters) of the fibrous structure, which unit area is taken in the plane of the fibrous structure. The size and shape of the unit area from which the basis weight is measured is dependent upon the relative and absolute sizes and shapes of the regions having different basis weights.

“Compressive stress” refers herein to the blunt force which, when applied to the fibrous structure, produces “compressed sites.” Compressive stress may not include shear force, which when applied to the fibrous structure, cuts the fibers comprising the web. Without wishing to be bound by theory, it is believed that the blunt force has less impact on the in use strength of the web than shear force since it mainly weakens the fibers at the edge of the compressed site instead of cutting them. Compressive stress is measured in units of Newtons per square millimeter (N/mm²).

“Compressed sites” refers herein to areas of the fibrous structure in which the fibers comprising the fibrous structure are pressed together such that the fibers are brought closer together in space as compared to the fibers that are located in the uncompressed regions. The compressed sites may have a higher fiber density as compared to the uncompressed regions.

“Dispersible” refers herein to a product which has the ability to exhibit visible changes after being flushed down a standard toilet and passed through a typical waste water system, which may include, but is not limited to, pumps, pipes, tanks, sieves, separation units and combinations thereof.

“Fail in tension” refers herein to a failure to the integrity of the product visible to the naked eye, such as, but not limited to, holes, slits, shreds, breaking apart into smaller sections, dissolving or a combination thereof. Any visible change when the fibrous structure is under force indicating weakening of the fibrous structure may be regarded as failing in tension. “Partially fails in tension” refers herein to when the failure of the integrity of the product is initiated.

“Fibrous structure” refers herein to an arrangement typically comprising a plurality of synthetic fibers, natural fibers, and combinations thereof. The synthetic fibers and/or natural fibers may be layered, as known in the art, to form the fibrous structure. The fibrous structure may be a nonwoven. The fibrous structure may be formed from a fibrous web and may be a precursor to a substrate.

“gsm” refers herein to “grams per square meter.”

“Hollow” refers herein to a molded element in which the molded element defines a shape, such as a circle. The border of the molded element may be molded, but the interior of the molded element may be unmolded space and, therefore, hollow. The border of the molded element need not fully enclose the unmolded space, but may be concave and/or convex relative to the interior unmolded space. The border of the molded element may be provided with gaps and may be considered a hollow element. A molded element, in an embodiment in which it is hollow, may comprise compressed sites within the interior of the molded element.

“Line of weakness” refers herein to an imaginary line drawn to connect a compressed site or series of compressed sites with the nearest adjacent compressed site or nearest series of compressed sites, respectively. The imaginary line may be straight or curved. When a fibrous structure is subjected to a force less than the maximum force of its discrete uncompressed regions, the fibrous structure fails in tension, or at least partially fails in tension, along the lines of weakness.

“Machine Direction” or “MD” refers herein to the direction of the fibrous structure travel as the fibrous structure is produced, for example on commercial nonwoven production equipment. “Cross Direction” or “CD” refers herein to the direction perpendicular to the machine direction and parallel to the general plane of the fibrous web. With respect to individual substrates, the terms refer to the corresponding directions of the substrate with respect to the fibrous structure used to produce the substrate. The mechanical properties of a nonwoven fibrous structure may differ depending on how the nonwoven fibrous structure is oriented during testing. For example, tensile properties of a fibrous structure may differ between the MD and the CD, due to the orientation of the constituent fibers and other process-related factors.

“Maximum force” refers herein to the stretching force necessary to cause the integrity of the fibrous structure or a portion of the fibrous structure to “fail in tension.” The maximum force of a fibrous structure may be measured by tensile testing in both the cross direction and the machine direction of the fibrous structure. Maximum force is measured in the unit of Newtons (N).

“Mechanical weakening” refers herein to reducing the tensile strength, or maximum force, of a fibrous structure through the introduction of lines of weakness comprised of compressed sites.

“Molded element” refers herein to a texture, pattern, image, graphic and combinations thereof on a molded fibrous structure that have been imparted by hydromolding. The hydromolded texture, pattern, image, graphic and combinations thereof need not extend, without interruption, from a first edge of the molded fibrous structure to a second edge of the molded fibrous structure. The molded element may be a discrete element separate from another molded element. A molded element may overlap another molded element.

“Molding member” refers to a structural element that can be used as a support for a fibrous structure. The molding member may “mold” a desired geometry to the fibrous structure. The molding member may comprise a molding pattern that may have the ability to impart the pattern onto a fibrous structure being conveyed thereon to produce a molded fibrous structure comprising a molded element.

“Nonwoven” refers to a fibrous structure made from an assembly of continuous fibers, coextruded fibers, noncontinuous fibers and combinations thereof, without weaving or knitting, by processes such as spunbonding, carding, meltblowing, air laying, wet laying, coform, or other such processes known in the art for such purposes. The nonwoven structure may comprise one or more layers of such fibrous assemblies, wherein each layer may include continuous fibers, coextruded fibers, noncontinuous fibers and combinations thereof.

“Substrate” refers herein to a piece of material, generally nonwoven material, used in cleaning or treating various surfaces, such as food, hard surfaces, inanimate objects, body parts, etc. For example, many currently available substrates may be intended for the cleansing of the perianal area after defecation. Other substrates may be available for the cleansing of the face or other body parts. A “substrate” may also be known as a “wipe” and both terms may be used interchangeably. Multiple substrates may be attached together by any suitable method to form a mitt.

“Uncompressed regions” refers herein to those areas of the fibrous structure that may not contain compressed sites. The fibers comprising the uncompressed regions of the fibrous structure may substantially remain in an unaltered form after the fibrous structure is subjected to compressive stress. “Substantially” is an adverb which as used herein means being largely, but not wholly.

“Un-melted fibers” refers herein to the fibers in the compressed sites, which are compressed by a blunt force to form a functional solid material in which there is no softening or melting of the fibers and consequently no bonding between the fibers, i.e., no mixing between the fibers on the molecular level. Therefore, if one could seize and pull on a single fiber in a compressed site, it would separate from other fibers in the compressed site.

“Visible” refers herein to being capable of being seen by the naked eye when viewed at a distance of 12 inches (in.) or 30.48 centimeters (cm.) under the unimpeded light of an ordinary incandescent 60 watt bulb that is inserted in a fixture such as a table lamp.

Fibrous Structure

Any conventional process for the formation of a nonwoven fibrous structure may be used. Non-limiting examples of formation processes include carding, spunmelt processes, spunlaying, coforming, meltblowing, air laying, wet laying, and the like. These conventional processes, may result in nonwoven fibrous structures with anisotropic tensile strength. Without being bound by theory, it is believed that the tensile strength in the Machine Direction is different from that in the Cross Direction. In an embodiment, the tensile strength in the Machine Direction may be greater than the tensile strength in the Cross Direction. Without being bound by theory, it is believed that this difference in tensile strength may be due to a partial orientation of the fibers, during the formation of the fibrous structure, parallel to the Machine Direction that may be brought about due to the increased velocity of the formation equipment in the Machine Direction (e.g., the forming belt is moving in the Machine Direction) relative to the Cross Direction.

The fibrous structure may comprise at least one compressed site. The compressed site may be discrete and may take any shape deemed suitable by one of skill in the art. Each of the compressed sites may have an area of less than about 2.5 mm². Without wishing to be bound by theory, it is believed that the compressed site may have a higher fiber density when compared to the density of uncompressed regions of the fibrous structure. The uncompressed regions of the fibrous structure may retain substantially the same density that the fibrous structure has before it is subjected to compressive stress. The compressed site may comprise un-melted fibers. The compressed sites may be randomly situated on the fibrous structure or may form a pattern. In an embodiment, the pattern may take the form of one or more lines of weakness. The pattern may further take the form of geometric shapes such as, but not limited to, squares, rectangles, triangles, hexagons, and combinations thereof. These geometric shapes may be defined by arrays of lines of weakness. These arrays of lines of weakness may be linearly continuous from edge-to-edge of the fibrous structure or they may be angled and not linearly continuous from edge-to-edge of the fibrous structure.

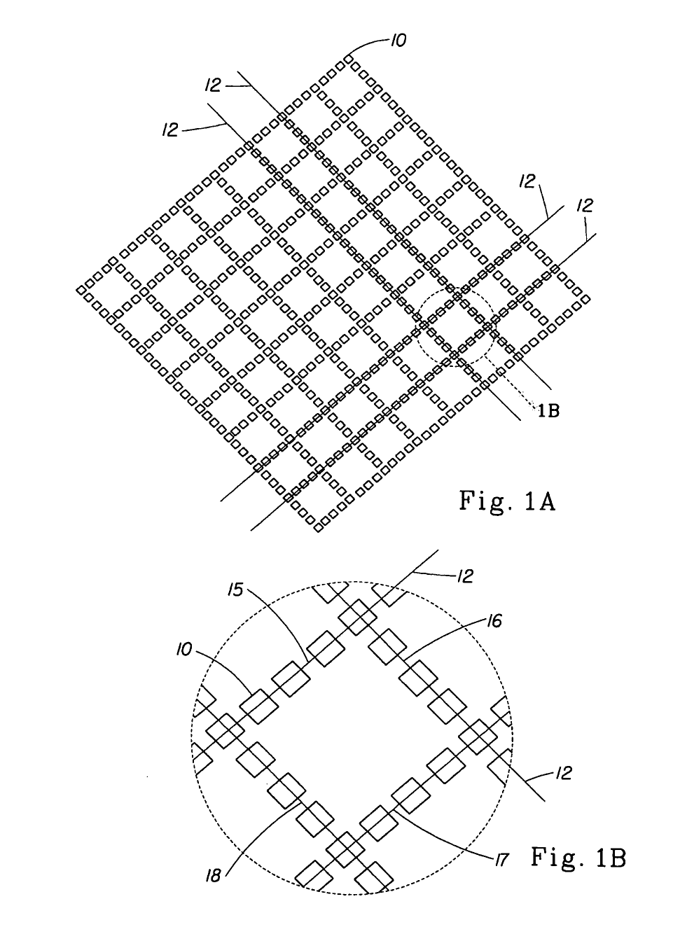

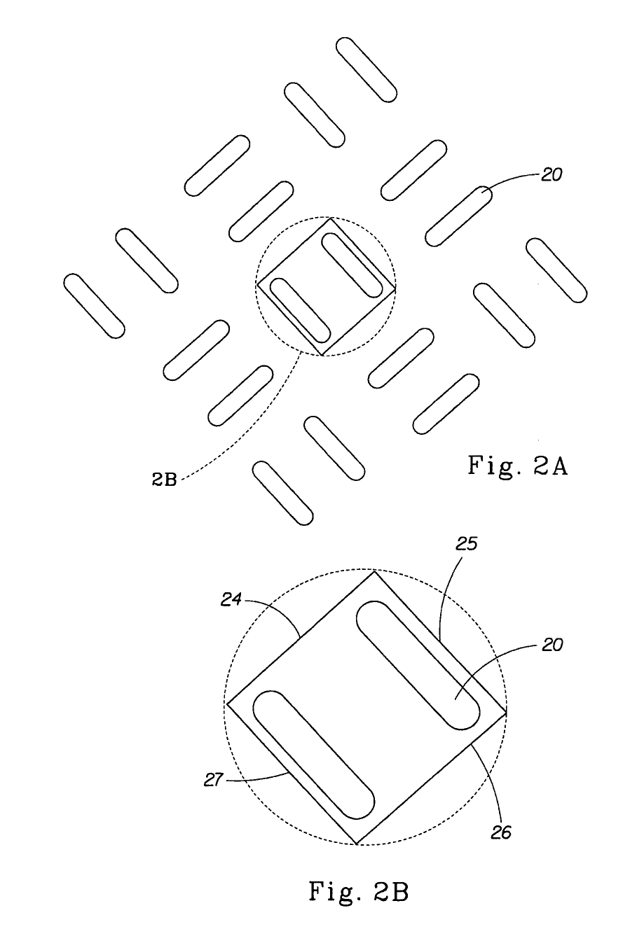

Examples of patterns may include, but are not limited to, the patterns shown in FIGS. 1A, 1B and 2, as well as variations thereof. FIG. 1 is an illustration of an embodiment of a pattern of compressed sites 10 which may form lines of weakness 12 wherein the lines of weakness 12 define geometric shapes. In this example, the compressed sites 10 form lines of weakness 12 which outline an overall diamond pattern (as shown in expanded form in FIG. 1B). It can be appreciated by one of skill in the art that any number of geometric patterns can be created by such a means. FIG. 2 is an illustration of an embodiment of a pattern of compressed sites 20 in which the compressed sites 20 do not form lines of weakness, but rather the compressed sites are elongated, and the direction of elongation alternates direction. It should be noted that the elongated compressed sites 20, and the pattern of alternating direction of the elongated compressed sites 20 may define a geometric shape, such as the lines of weakness in FIG. 1. In FIG. 2, the alternating direction of the elongated compressed sites 20 may outline an overall square pattern (as shown in expanded FIG. 2B). It can be appreciated by one of skill in the art that any of a number of geometric patterns can be created by such a means.

In an embodiment in which the pattern of compressed sites takes the form of geometric shapes, the geometric shapes may have a size. The size may be defined as the perimeter of the smallest repeating unit in the array of geometric shapes defined by the compressed sites. For example, in FIG. 1B the perimeter of the diamond pattern may be formed by sides 15, 16, 17, and 18. In FIG. 2B, the perimeter of the square pattern may be formed by sides 24, 25, 26 and 27. It should be noted that the four perimeter sides are drawn for representative purposes only to illustrate the perimeter of a square, and form no part of the actual pattern.

The fibrous structure may comprise at least one molded element. Molded elements may provide a visual signal to the user that the substrate is soft, strong, flexible, and provides an improved cleansing benefit. The molded elements may be randomly arranged or may be in a repetitive pattern. The molded element may comprise any image, graphic, texture, pattern or combinations thereof. The molded element may be any shape deemed suitable by one of ordinary skill. The molded element may include a number of decorative patterns. Such patterns may include, but are not limited to, regular arrays of small geometric shapes (i.e. circles), regular repeating patterns of lines and curves, images of animals, and combinations thereof. The molded element may be in the form of logos, indicia, trademarks, geometric patterns, images of the surfaces the fibrous structure is intended to clean (i.e., infant's body, face, etc.). The logos, indicia, trademarks, geometric patterns or images may be similar to those found in other areas of the total product, including, but not limited to, the outer packaging, inner packaging, advertising materials, informational materials and combinations thereof. Non-limiting examples of the molded element may include circles, squares, rectangles, ovals, ellipses, irregular circles, swirls, curly cues, cross hatches, pebbles, lined circles, linked irregular circles, half circles, wavy lines, bubble lines, puzzles, leaves, outlined leaves, plates, connected circles, changing curves, dots, honeycombs, animal images such as paw prints, etc. and combinations thereof. The molded element may be a hollow element. The molded element may be connected to another molded element. A molded element may overlap another molded element.

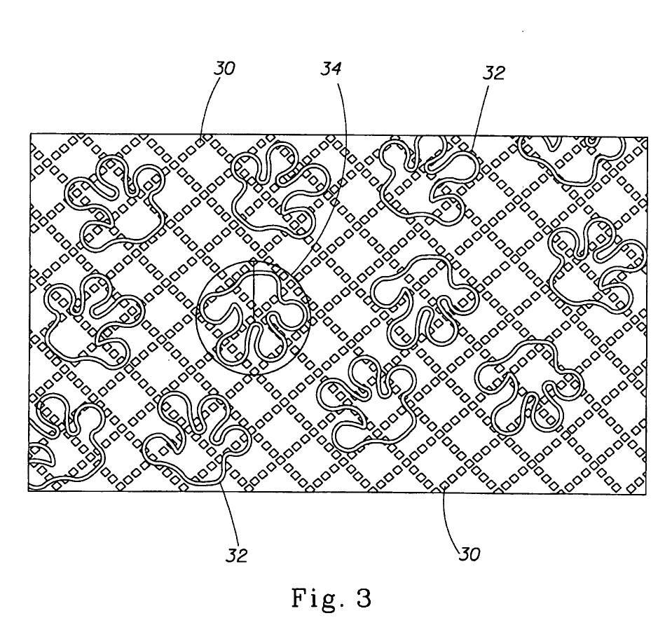

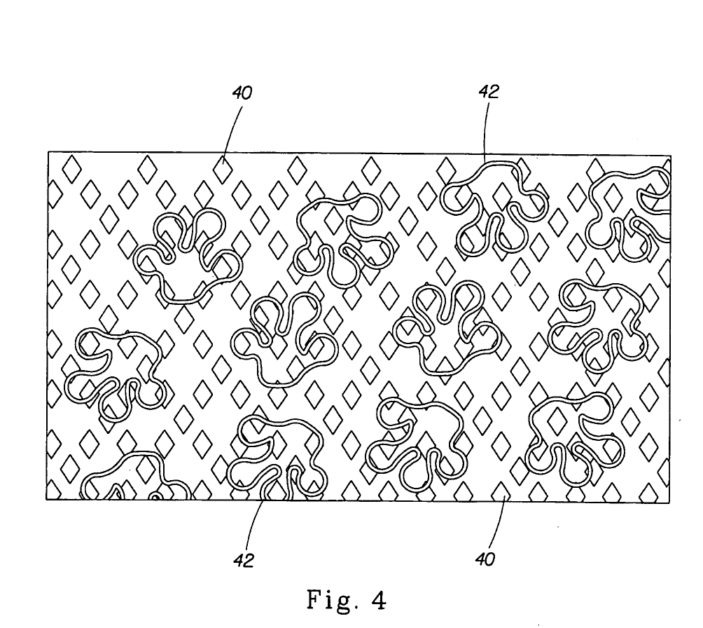

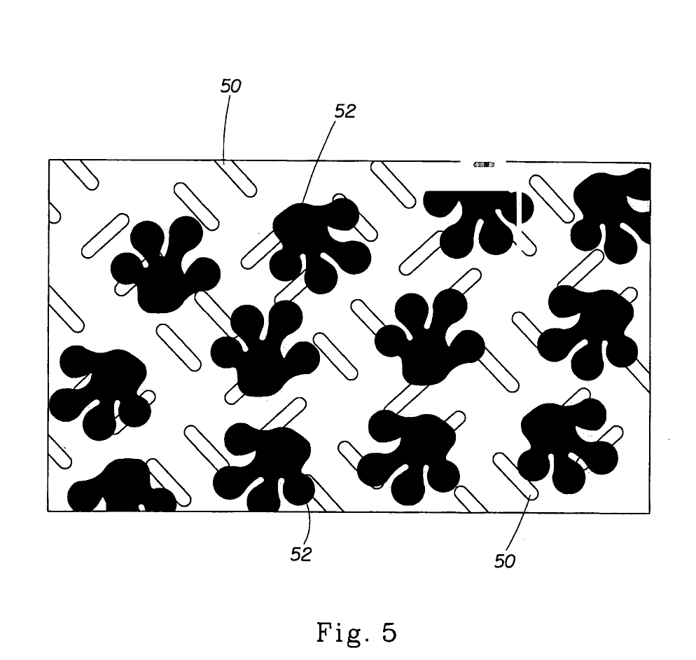

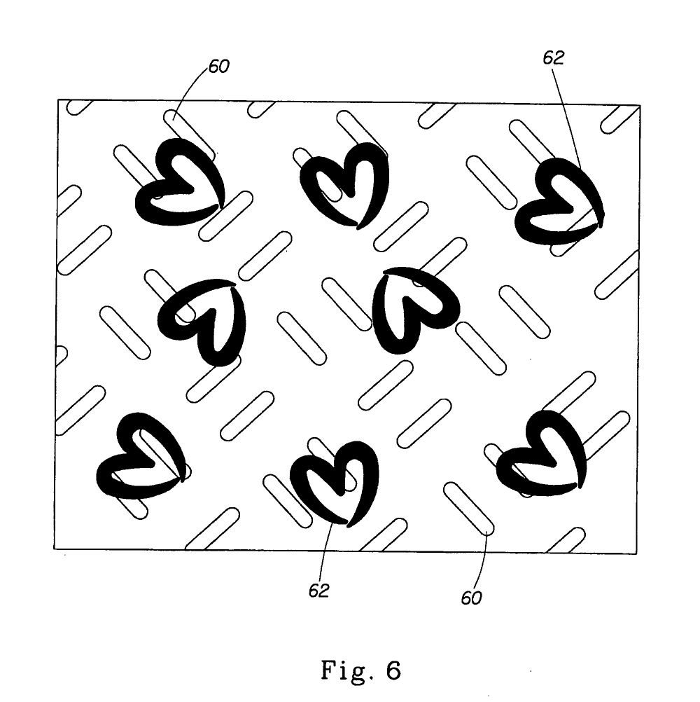

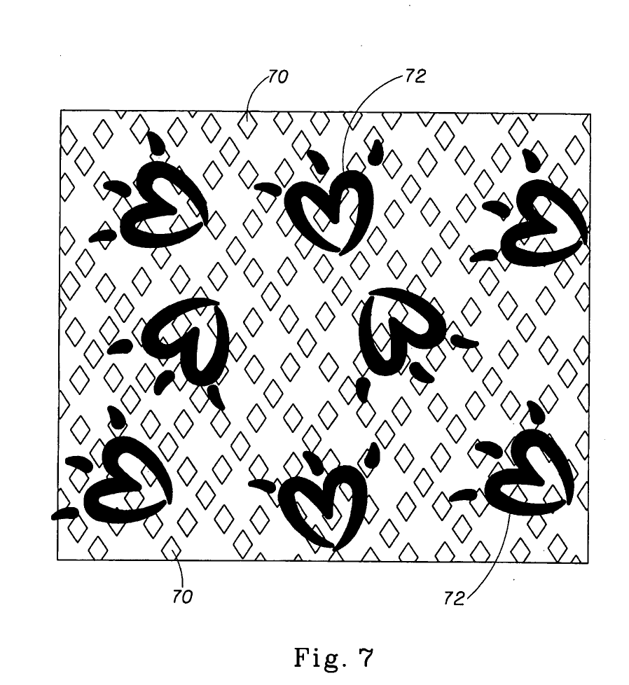

The fibrous structure may comprise at least one compressed site and at least one molded element. In an embodiment, the compressed site and the molded element may overlap. In an embodiment, the compressed site and the molded element may be adjacent to each other. In an embodiment, the compressed site and the molded element may be separate and discrete from each other. In an embodiment, a compressed site may be located within the interior of a molded element, such as a hollow molded element. FIGS. 3-7 are non-limiting examples of embodiments of a fibrous structure comprising at least one compressed site and at least one molded element. FIG. 3 is an illustration of an embodiment of a pattern of compressed sites 30 and a molded element 32 in the shape of a paw. In such an embodiment, the paw is illustrated as a hollow molded element. FIG. 3 further contains an illustration of a size-radius 34 as described below. FIG. 4 is an illustration of an embodiment of a pattern of larger compressed sites 40 and a hollow molded element 42 in the shape of a paw. FIG. 5 is an illustration of an embodiment of a pattern of compressed sites 50 and a molded element 52 in the shape of a paw. FIG. 6 is an illustration of an embodiment of a pattern of compressed sites 60 and a molded element 62 in the shape of a heart. FIG. 7 is an illustration of a pattern of compressed sites 70 and a molded element 72 in the shape of a heart with rays emanating from the heart.

The fibrous structure comprising at least one compressed site and at least one molded element may be configured to enhance the visual clarity of the molded element. The molded element may have a size. The size may be defined as a size-radius. The size-radius may be taken as the smallest circle that can completely contain the molded element. In an embodiment, the molded element may be continuous from edge-to-edge of the fibrous structure. In an embodiment, the molded element need not be continuous from edge-to-edge of the fibrous structure. In an embodiment, the size-radius of the molded element may be larger than the size of the geometric shape of the pattern of compressed sites (such as in FIG. 3). In an embodiment, the size-radius of the molded element may be smaller than the size of the geometric shape of the pattern of compressed sites (such as in FIG. 6). In an embodiment, the size-radius of the molded element may be similar to the size of the geometric shape of the pattern of compressed sites (such as in FIG. 4).

The fibrous structure may be characterized by its mechanical properties. Mechanical properties include, but are not limited to, tensile strength, stretching modulus, and bending modulus. Tensile strength may also be known as maximum force. The fibrous structure may have different mechanical properties depending on the direction in which the mechanical property is measured. For example, the fibrous structure may have a tensile strength in the Machine Direction, also known as the MD-tensile, and a tensile strength in the Cross Direction, also known as the CD-tensile. The MD-tensile may be different from the CD-tensile. In an embodiment, the MD-tensile may be greater than the CD-tensile. The fibrous structure may have a modulus in the Machine Direction, also known as the MD-modulus, and a modulus in the Cross Direction, also known as the CD-modulus. The modulus may be a stretching modulus or a bending modulus. The MD-modulus may be different from the CD-modulus. In an embodiment, the MD-modulus may be greater than the CD-modulus.

The introduction of the compressed sites may have an effect on the tensile strength of the fibrous structure. Tensile strength may be measured as the MD maximum force and as the CD maximum force. Both the MD and CD maximum forces decrease as the compressive stress applied to the fibrous structure increases. Without wishing to be bound by theory, it is believed that by increasing the compressive stress, the fibers comprising the fibrous structure are increasingly weakened, which in turn, decreases the maximum force necessary to cause the fibrous structure to fail in tension. While it may be desirable to have a fibrous structure which fails in tension under relatively low MD and/or CD maximum forces to aid in dispersability, it may not be desirable to have the forces so low as to produce a fibrous structure with insufficient in use strength. This may further be true when the fibrous structure may be utilized as a moistened substrate. Therefore, it may be desirable to balance the MD and CD maximum forced for both dispersability and in use strength.

The fibers of the fibrous structure may be non-thermoplastic. The fibers of the fibrous structure may be any natural, cellulosic, and/or synthetic material. Examples of natural fibers may include cellulosic natural fibers, such as fibers from hardwood sources, softwood sources, or other non-wood plants. The natural fibers may comprise cellulose, starch and combinations thereof. Nonlimiting examples of suitable cellulosic natural fibers include, but are not limited to, wood pulp, typical northern softwood Kraft, typical southern softwood Kraft, typical CTMP, typical deinked, corn pulp, acacia, eucalyptus, aspen, reed pulp, birch, maple, radiata pine, and combinations thereof. Other sources of natural fibers from plants include, but are not limited to, albardine, esparto, wheat, rice, corn, sugar cane, papyrus, jute, reed, sabia, raphia, bamboo, sidal, kenaf, abaca, sunn, cotton, hemp, flax, ramie, and combinations thereof. Yet other natural fibers may include fibers from other natural non-plant sources, such as, down, feathers, silk, and combinations thereof. The natural fibers may include extruded cellulose such as rayon (also known as viscose), tencell, and lyocell. The natural fibers may be treated or otherwise modified mechanically or chemically to provide desired characteristics or may be in a form that is generally similar to the form in which they can be found in nature. Mechanical and/or chemical manipulation of natural fibers does not exclude them from what are considered natural fibers with respect to the development described herein. In an embodiment, the fibrous structure may comprise a 60/40 blend of lyocell and pulp fibers. In an embodiment, the fibrous structure may comprise a 60/40 blend of viscose and pulp fibers. In an embodiment, the fibrous structure may comprise a 30/30/40 blend of viscose, lyocell and pulp fibers.

The synthetic fibers can be any material, such as, but not limited to, those selected from the group consisting of polyesters (e.g., polyethylene terephthalate), polyolefins, polypropylenes, polyethylenes, polyethers, polyamides, polyesteramides, polyvinylalcohols, polyhydroxyalkanoates, polysaccharides, and combinations thereof. The synthetic fibers may also include thermoplastic-biodegradable fibers, such as, but not limited to, poly-lactic-acid and its derivatives. Further, the synthetic fibers can be a single component (i.e., single synthetic material or mixture makes up entire fiber), bicomponent (i.e., the fiber is divided into regions, the regions including two or more different synthetic materials or mixtures thereof and may include coextruded fibers and core and sheath fibers) and combinations thereof. These bicomponent fibers can be used as a component fiber of the structure, they may be present to act as a binder for the other fibers present in the fibrous structure and/or they may be the only type of fiber present in the fibrous structure. Any or all of the synthetic fibers may be treated before, during, or after the process of the present invention to change any desired properties of the fibers. For example, in certain embodiments, it may be desirable to treat the synthetic fibers before or during processing to make them more hydrophilic, more wettable, etc.

In certain embodiments of the present invention, it may be desirable to have particular combinations of fibers to provide desired characteristics. For example, it may be desirable to have fibers of certain lengths, widths, coarseness or other characteristics combined in certain layers or separate from each other. The fibers may be of virtually any size and may have an average length from about 1 mm to about 60 mm. Average fiber length refers to the length of the individual fibers if straightened out. The fibers may have an average fiber width of greater than about 5 micrometers. The fibers may have an average fiber width of from about 5, 10, 15, 20 or 25 micrometers to about 30, 35, 40, 45 or 50 micrometers. The fibers may have a coarseness of greater than about 5 mg/100 m. The fibers may have a coarseness of from about 5 mg/100 m, 15 mg/100 m, 25 mg/100 m to about 50 mg/100 m, 60 mg/100 m or 75 mg/100 m.

The fibers may be circular in cross-section, dog bone shaped, delta (i.e., triangular cross-section), trilobal, ribbon, or other shapes typically produced as staple fibers. Likewise, the fibers can be conjugate fibers. The fibers may be crimped, and may have a finish, such as a lubricant, applied.

The fibrous structure of the present invention may take a number of different forms. The fibrous structure may comprise 100% synthetic fibers or may be a combination of synthetic fibers and natural fibers. In one embodiment of the present invention, the fibrous structure may include one or more layers of a plurality of synthetic fibers mixed with a plurality of natural fibers. The synthetic fiber/natural fiber mix may be relatively homogeneous in that the different fibers may be dispersed generally randomly throughout the layer. The fiber mix may be structured such that the synthetic fibers and natural fibers may be disposed generally nonrandomly. In one embodiment, the fibrous structure may include at least one layer comprising a plurality of natural fibers and at least one adjacent layer comprising a plurality of synthetic fibers. In another embodiment, the fibrous structure may include at least one layer that comprises a plurality of synthetic fibers homogeneously mixed with a plurality of natural fibers and at least one adjacent layer that comprises a plurality of natural fibers. In an alternate embodiment, the fibrous structure may include at least one layer that comprises a plurality of natural fibers and at least one adjacent layer that may comprise a mixture of a plurality of synthetic fibers and a plurality of natural fibers in which the synthetic fibers and/or natural fibers may be disposed generally nonrandomly. Further, one or more of the layers of mixed natural fibers and synthetic fibers may be subjected to manipulation during or after the formation of the fibrous structure to disperse the layer or layers of mixed synthetic and natural fibers in a predetermined pattern or other nonrandom pattern.

Additional information relating to the fibrous structure may be found in U.S. Patent Publication Nos. 2004/0154768; 2004/0157524; 2006/0134386 and 2006/0135018; and U.S. Pat. Nos. 4,588,457; 5,397,435 and 5,405,501.

### Substrate

The fibrous structure, as described above, may be utilized to form a substrate. The fibrous structure may be processed in any method known to one of ordinary skill to convert the fibrous structure to a substrate comprising at least one compressed site and at least one molded element. This may include, but is not limited to, slitting, cutting, perforating, folding, stacking, interleaving, lotioning and combinations thereof. The fibrous structure from which a substrate is made should be strong enough to resist tearing during manufacture and normal use, yet still provide softness to the user's skin, such as a child's tender skin. Additionally, the fibrous structure should be at least capable of retaining its form for the duration of the user's cleansing experience.

Substrates may be generally of sufficient dimension to allow for convenient handling. Typically, the substrate may be cut and/or folded to such dimensions as part of the manufacturing process. In some instances, the substrate may be cut into individual portions so as to provide separate wipes which are often stacked and interleaved in consumer packaging. In other embodiments, the substrates may be in a web form where the web has been slit and folded to a predetermined width and provided with means (e.g., perforations) to allow individual wipes to be separated from the web by a user. Suitably, the separate wipes may have a length between about 100 mm and about 250 mm and a width between about 140 mm and about 250 mm. In one embodiment, the separate wipe may be about 200 mm long and about 180 mm wide.

The material of the substrate may generally be soft and flexible, potentially having a structured surface to enhance its performance. It is also within the scope of the present invention that the substrate may include laminates of two or more materials. Commercially available laminates, or purposely built laminates would be within the scope of the present invention. The laminated materials may be joined or bonded together in any suitable fashion, such as, but not limited to, ultrasonic bonding, adhesive, glue, fusion bonding, heat bonding, thermal bonding, hydroentangling and combinations thereof. In another alternative embodiment of the present invention the substrate may be a laminate comprising one or more layers of nonwoven materials and one or more layers of film. Examples of such optional films, include, but are not limited to, polyolefin films, such as, polyethylene film. An illustrative, but nonlimiting example of a nonwoven sheet member which is a laminate of a 16 gsm nonwoven polypropylene and a 0.8 mm 20 gsm polyethylene film.

The substrate materials may also be treated to improve the softness and texture thereof. The substrate may be subjected to various treatments, such as, but not limited to, physical treatment, such as ring rolling, as described in U.S. Pat. No. 5,143,679; structural elongation, as described in U.S. Pat. No. 5,518,801; consolidation, as described in U.S. Pat. Nos. 5,914,084, 6,114,263, 6,129,801 and 6,383,431; stretch aperturing, as described in U.S. Pat. Nos. 5,628,097, 5,658,639 and 5,916,661; differential elongation, as described in WO Publication No. 2003/0028165A1; and other solid state formation technologies as described in U.S. Publication Nos. 2004/0131820A1 and 2004/0265534A1, zone activation, and the like; chemical treatment, such as, but not limited to, rendering part or all of the substrate hydrophobic, and/or hydrophilic, and the like; thermal treatment, such as, but not limited to, softening of fibers by heating, thermal bonding and the like; and combinations thereof.

The substrate may have a basis weight of at least about 30 grams/m². The substrate may have a basis weight of at least about 40 grams/m². In one embodiment, the substrate may have a basis weight of at least about 45 grams/m². In another embodiment, the substrate basis weight may be less than about 100 grams/m². In another embodiment, substrates may have a basis weight between about 30 grams/m² and about 100 grams/m², and in yet another embodiment a basis weight between about 40 grams/m² and about 90 grams/m². The substrate may have a basis weight between about 30, 40, 45, 50 or 55 and about 60, 65, 70, 75, 80, 90 or 100 grams/m².

In one embodiment of the present invention the surface of substrate may be essentially flat. In another embodiment of the present invention the surface of the substrate may optionally contain raised and/or lowered portions. These can be in the form of logos, indicia, trademarks, geometric patterns, images of the surfaces that the substrate is intended to clean (i.e., infant's body, face, etc.). They may be randomly arranged on the surface of the substrate or be in a repetitive pattern of some form.

In another embodiment of the present invention the substrate may be biodegradable. For example, the substrate could be made from a biodegradable material such as a polyesteramide, or a high wet strength cellulose.

### Composition

The substrate may associate with a composition. The composition may generally comprise the following optional components: emollients, surfactants, rheology modifiers, preservatives, or a combination of preservative compounds acting together as a preservative system, and water. Other components may be incorporated into the composition, including, but not limited to, soothing agents, vitamins, minerals, antioxidants, moisturizers, botanicals, fragrances, potentiators, aesthetic enhancing ingredients, texturizers, colorants, medically active ingredients, such as healing actives and skin protectants and additional skin health benefit ingredients. It is to be noted that some components can have a multiple function and that all components are not necessarily present in the composition. The composition may be an oil-in-water emulsion. The pH of the composition may be from about pH 3, 4 or 5 to about pH 7, 7.5, or 9. The composition may have a water content level of greater than about 50%, 60%, 70% or 85%. The composition may have a water content less than about 25%, 15%, or 10% for use with a primarily dry substrate.

Emollients may include silicone oils, functionalized silicone oils, hydrocarbon oils, fatty alcohols, fatty alcohol ethers, fatty acids, esters of monobasic and/or dibasic and/or tribasic and/or polybasic carboxylic acids with mono and polyhydric alcohols, polyoxyethylenes, polyoxypropylenes, mixtures of polyoxyethylene and polyoxypropylene ethers of fatty alcohols, and mixtures thereof. The emollients may be either saturated or unsaturated, have an aliphatic character and be straight or branched chained or contain alicyclic or aromatic rings. An example of an emollient is caprylic capric triglycerides in combination with Bis-PEG/PPG-16/16 PEG/PPG-16/16 dimethicone known as ABIL CARE™ 85 (available from Degussa Care Specialties of Hopewell, Va.). Emollients, when present, may be used at a weight/weight % (w/w) of the composition from about 0.5%, 1% or 4% to about 0.001%, 0.01%, or 0.02% w/w.

The surfactant can be an individual surfactant or a mixture of surfactants. The surfactant may be a polymeric surfactant or a non-polymeric one. The surfactant may be employed as an emulsifier. The surfactant, when present, may be employed in an amount effective to emulsify the emollient and any other non-water-soluble oils that may be present in the composition, such as an amount ranging from about 0.5%, 1%, or 4% w/w to about 0.001%, 0.01% or 0.02% w/w (based on the weight surfactant over the weight of the composition).

The composition may include one or more surfactants. The surfactant or combinations of surfactants may be mild, which means that the surfactants provide sufficient cleansing or detersive benefits but do not overly dry or otherwise harm or damage the skin. The surfactant may include those selected from the group consisting of anionic surfactants, nonionic surfactants, cationic surfactants, amphoteric surfactants, zwitterionic surfactants, and mixtures thereof.

Examples of rheology modifiers include, but are not limited to, Ultrez™-10, a carbomer, and Pemulen™ TR-2, an acrylate crosspolymer, both of which are available from Noveon, Cleveland Ohio, and Keltrol™, a Xanthan gum, available from CP Kelco, San Diego Calif., and combinations thereof. Rheology modifiers, when present, may be used at a weight/weight % (w/w) of the composition from about 0.01%, 0.015%, or 0.02% to about 1%, 2% or 3%.

The lotion composition may comprise a preservative or a combination of preservatives acting together as a preservative system. A preservative may be understood to be a chemical or natural compound or a combination of compounds reducing the growth of microorganisms. Materials useful as preservatives include, but are not limited to: methylol compounds, iodopropynyl compounds, simple aromatic alcohols, paraben compounds, chelators such as ethylenediamine tetraacetic acid, and combinations thereof.

Additional details on the substrate and composition may be found in U.S. Pat. No. 6,716,805 issued to Sherry et al.; US Publication Nos. 2003/0126709 by Policicchio et al., 2005/0081888 by Pung et al., and 2006/0177488 by Caruso et al.

### Method of Making Fibrous Structure

Generally, the process of the present invention for making a fibrous structure may be described in terms of initially forming a fibrous web having a plurality of synthetic fibers and/or natural fibers. Layered deposition of the fibers, synthetic and natural, is also contemplated by the present invention. The fibrous web can be formed in any conventional fashion and may be any web that may be suitable for use in a hydromolding process. The fibrous web may consist of any web, mat, or batt of loose fibers disposed in any relationship with one another or in any degree of alignment, such as might be produced by carding, air laying, spunmelting (including meltblowing and spunlaying), coforming and the like.

Conducting the carding, spunmelting, spunlaying, meltblowing, coforming, air laying or other formation processes concurrently with the fibers contacting a forming member may produce a fibrous web. The process may involve subjecting the fibrous web to a hydroentanglement process while the fibrous web is in contact with the forming member. The hydroentanglement process (also known as spunlacing or spunbonding) is a known process of producing nonwoven webs, and involves laying down a matrix of fibers, for example as a carded web or an air laid web, and entangling the fibers to form a coherent web. Entangling is typically accomplished by impinging the matrix of fibers with high pressure liquid (typically water) from at least one, at least two, or a plurality of suitably placed water jets. The pressure of the liquid jets, as well as the orifice size and the energy imparted to the fibers by the water jets, may be the same as those of a conventional hydroentangling process. Typically, entanglement energy may be about 0.1 kwh/kg. While other fluids can be used as the impinging medium, such as compressed air, water is the preferred medium. The fibers of the web are thus entangled, but not physically bonded one to another. The fibers of a hydroentangled web, therefore, have more freedom of movement than fibers of webs formed by thermal or chemical bonding. Particularly when lubricated by wetting as a pre-moistened wet wipe, such spunlaced webs provide webs having very low bending torques and low moduli, thereby achieving softness and suppleness.

Additional information on hydroentanglement can be found in U.S. Pat. No. 3,485,706 issued on Dec. 23, 1969, to Evans; U.S. Pat. No. 3,800,364 issued on Apr. 2, 1974, to Kalwaites; U.S. Pat. No. 3,917,785 issued on Nov. 4, 1975, to Kalwaites; U.S. Pat. No. 4,379,799 issued on Apr. 12, 1983, to Holmes; U.S. Pat. No. 4,665,597 issued on May 19, 1987, to Suzuki; U.S. Pat. No. 4,718,152 issued on Jan. 12, 1988, to Suzuki; U.S. Pat. No. 4,868,958 issued on Sep. 26, 1989, to Suzuki; U.S. Pat. No. 5,115,544 issued on May 26, 1992, to Widen; and U.S. Pat. No. 6,361,784 issued on Mar. 26, 2002, to Brennan.

The fibrous web may further comprise binder materials. The fibrous web may comprise from about 0.01% to about 1%, 3%, or 5% by weight of a binder material selected from the group consisting of permanent wet strength resins, temporary wet strength resins, dry strength resins, retention aid resins and combinations thereof.

If permanent wet strength is desired, the binder materials may be selected from the group consisting of polyamide-epichlorohydrin, polyacrylamides, styrene-butadiene latexes, insolubilized polyvinyl alcohol, ureaformaldehyde, polyethyleneimine, chitosan polymers and combinations thereof.

If temporary wet strength is desired, the binder materials may be starch based. Starch based temporary wet strength resins may be selected from the group consisting of cationic dialdehyde starch based resin, dialdehyde starch and combinations thereof. The resin described in U.S. Pat. No. 4,981,557, issued Jan. 1, 1991 to Bjorkquist may also be used.

If dry strength is desired, the binder materials may be selected from the group consisting of polyacrylamide, starch, polyvinyl alcohol, guar or locust bean gums, polyacrylate latexes, carboxymethyl cellulose and combinations thereof.

A latex binder may also be utilized. Such a latex binder may have a glass transition temperature from about 0° C., −10° C., or −20° C. to about −40° C., −60° C., or −80° C. Examples of latex binders that may be used include polymers and copolymers of acrylate esters, referred to generally as acrylic polymers, vinyl acetate-ethylene copolymers, styrene-butadiene copolymers, vinyl chloride polymers, vinylidene chloride polymers, vinyl chloride-vinylidene chloride copolymers, acrylo-nitrile copolymers, acrylic-ethylene copolymers and combinations thereof. The water emulsions of these latex binders usually contain surfactants. These surfactants may be modified during drying and curing so that they become incapable of rewetting.

Methods of application of the binder materials may include aqueous emulsion, wet end addition, spraying and printing. At least an effective amount of binder may be applied to the fibrous web. Between about 0.01% and about 1.0%, 3.0% or 5.0% may be retained on the fibrous web, calculated on a dry fiber weight basis. The binder may be applied to the fibrous web in an intermittent pattern generally covering less than about 50% of the surface area of the web. The binder may also be applied to the fibrous web in a pattern to generally cover greater than about 50% of the fibrous web. The binder material may be disposed on the fibrous web in a random distribution. Alternatively, the binder material may be disposed on the fibrous web in a nonrandom repeating pattern.

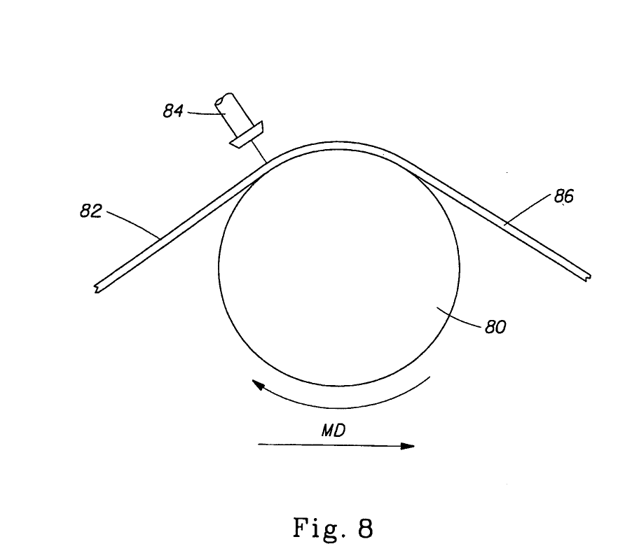

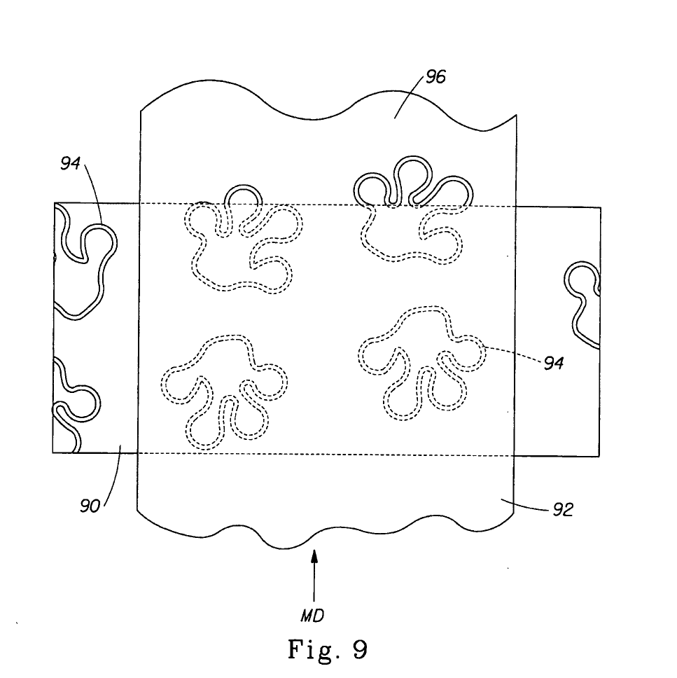

After the fibrous web has been formed, it can be subjected to additional process steps, such as, hydromolding (also known as molding, hydroembossing, hydraulic needlepunching, etc.). FIG. 8 illustrates a side view of a molding member 80 with a fibrous web 82 being conveyed over the top of the molding member 80. A single jet 84, or multiple jets, may be utilized. Water or any other appropriate fluid medium may be ejected from the jet 84 to impact the fibrous web 82. The fluid may impact the fibrous web in a continuous flow or noncontinuous flow. The molding member 80 may comprise a molding pattern (as exemplified in FIG. 9). The molding pattern may comprise raised areas, lowered areas, or combinations thereof interspersed thereon. Raised areas may also incorporate solid areas. Lowered areas may also incorporate void areas. As the fluid from the jet(s) 84 impacts the fibrous web 82, the fibrous web 82 may conform to the molding pattern. The fluid may “push” portions of the fibrous web 82 into lowered areas of the pattern. The result may be a molded fibrous structure 86. The molding pattern of raised and/or lowered areas may comprise images, graphics or combinations thereof and may comprise logos, indicia, trademarks, geometric patterns, images of the surfaces that a substrate (as discussed herein) is intended to clean (i.e., infant's body, face, etc.) or combinations thereof. They may be utilized in a random or alternating manner or they may be used in a consecutive, repeating manner. The images, graphics or combinations thereof may be a single image or graphic, a group of images or graphics, a repeating pattern of images or graphics, a continuous image or graphic, and combinations thereof.

FIG. 9 illustrates a top view of a molding member 90 with a fibrous web 92 conveyed over the top of the molding member 90. A pattern 94 may be molded onto the fibrous web 92 by a hydromolding process. In such a process, fluid may be directed towards the fibrous web 92 in such as manner as to impact the fibrous web 92 causing it to conform to the pattern 94 on the molding member 90 resulting in a molded fibrous structure 96.

To impart compressed sites to the fibrous structure, any method of applying compressive stress to the fibrous structure may be used. Methods of applying compressive stress to the fibrous structure include, but are not limited to, stamping, pressing, cold calendar rolling, heated calendar rolling, and combinations thereof. The compressive stress may smash or compress the fibers with a blunt force, in contrast to other methods of applying stress in which the fibers are sheared or cut with a sharp edge. After application of compressive stress to the fibrous structure, the compressed sites may comprise more than about 2%, 3%, or 5% of the total fibrous structure surface area. The percentage of total fibrous structure surface area that may comprise the compressed sites is greater than at least about 2% in order to weaken the web sufficiently such that it may fail along the lines of weakness when subjected to forces encountered by the fibrous structure during or after disposal.

In an embodiment, the hydromolding of the fibrous structure may occur after the application of the compressive stress. In an embodiment, the hydromolding of the fibrous structure may occur prior to the application of the compressive stress. Without being bound by theory, it is believed that in such an embodiment, the performance of the process steps in which the hydromolding precedes the application of compressive stress may decrease the possibility of the fibrous structure failing in tension during the process steps. It is believed that the tensile strength of the fibrous structure is lessened during the application of the compressive stress and this may cause the fibrous structure to weaken to an extent that it may create difficulty in hydromolding a fibrous structure comprising compressed sites.

The fibrous structure comprising at least one compressed site and at least one molded element may continue to be processed in any method known to one of ordinary skill to covert the molded fibrous structure to a substrate suitable for use as a wipe. This may include, but is not limited to, slitting, cutting, perforating, folding, stacking, interleaving, lotioning and combinations thereof.

### EXAMPLES

### Example 1

A nonwoven fibrous structure comprising about 60% lyocell fibers (supplied by Lenzing AG) and 40% pulp fibers (supplied by Koch Industries) may comprise at least one compressed site and at least one molded element.

A fibrous web may be made following a typical carded spunlace process. The lyocell fibers may be carded during the laydown and the pulp fibers may be airlaid. The fibers may be hydroentangled via a 4-drum Fleissner Aquajet entanglement unit to form a consolidated web that may be slitted, wound and packaged into a finished roll.

The fibrous web may be unwound onto a flexible belt comprising a three-dimensional forming pattern (hydromolding screen). The web may be passed beneath two hydroentanglement heads, each of which may have a vacuum dewatering slot beneath the belt to remove excess water. Each hydroentanglement head (also known as a jet) may comprise a pressure manifold and a metal “jet strip” containing orifices through which water is passed at high pressure and velocity. The first hydroentanglement head may have a pressure of about 50 bar and the second hydroentanglement head may have a pressure of about 90 bar. The jet strip may comprise a 120 micron orifice, 40 holes per inch, single row. Following the formation of the three-dimensional molded element, the molded fibrous structure is passed through an air dryer to bring the moisture below the ambient equilibrium moisture level and wound onto a roll. The dry temperature may be about 140° C. The web speed may be about 10 meters per minute (“mpm”).

The molded fibrous structure may be unwound and passed (at a nominal width of about 230 mm) through a vertically oriented two roll embossing nip in which the top roller comprises the pattern and the bottom roller is an anvil, or smooth, roller. Each roller is maintained at a constant temperature (via resistance heaters) and the rolls are loaded together via hydraulic cylinders maintained at a constant pressure. The temperature of the rollers may be about 250° F. and the cylinder pressure may be about 110 psi. The velocity may be about 30 mpm.

The nonwoven fibrous structure may comprise at least one molded element in the shape of a paw and at least one compressed site. The fibrous structure may comprise an array of compressed sites that may form a geometric pattern such as a diamond.

### Example 2

A nonwoven fibrous structure comprising about 60% lyocell fibers (supplied by Lenzing AG) and 40% pulp fibers (supplied by Koch Industries) may comprise at least one compressed site and at least one molded element.

A fibrous web may be made following a typical carded spunlace process. The lyocell fibers may be carded during the laydown and the pulp fibers may be airlaid. The fibers may be hydroentangled via a 4-drum Fleissner Aquajet entanglement unit to form a consolidated web that may be slitted, wound and packaged into a finished roll.

The fibrous web may be unwound into a typical three drum hydroentanglement unit in which the third drum may comprise a three-dimensional forming member (hydromolding screen). The fibrous web is passed beneath a series of hydroentanglement heads (also known as jets), each having an associated vacuum dewatering slot beneath to remove excess water. A first series of hydroentanglement heads may comprise two heads in which the first head has a pressure of about 15 bar and the second head has a pressure of about 30 bar. A second series of hydroentanglement heads may comprise a single head with a pressure of about 30 bar. A third series of hydroentanglement heads may comprise two heads in which the first head may have a pressure of about 100 bar and the second head may have a pressure of about 125 bar. Each hydroentanglement head may comprise a pressure manifold and a metal “jet strip” containing orifices through which water may be passed at high pressure and velocity. The jet strip may comprise a 120 micron orifice, 40 holes per inch, single row. Following formation of the three-dimensional molded element, the molded fibrous structure may be passed through an air drum dryer to bring the moisture below the ambient equilibrium moisture level and wound onto a roll. The dryer temperature may be about 180° C. The web speed may be about 150 mpm.

The molded fibrous structure may be unwound and passed (at a nominal width of about 230 mm) through a vertically oriented two roll embossing nip in which the top roller comprises the pattern and the bottom roller is an anvil, or smooth, roller. Each roller is maintained at a constant temperature (via resistance heaters) and the rolls are loaded together via hydraulic cylinders maintained at a constant pressure. The temperature of the rollers may be about 250° F. and the cylinder pressure may be about 110 psi. The velocity may be about 30 mpm.

The nonwoven fibrous structure may comprise at least one molded element in the shape of a paw and at least one compressed site. The fibrous structure may comprise an array of compressed sites that may form a geometric pattern such as a diamond.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A nonwoven fibrous structure comprising at least one compressed site and at least one molded element wherein said compressed site comprises un-melted fibers.

2. The nonwoven fibrous structure of claim 1 wherein said at least one compressed site comprises less than about 2.5 square millimeters in area.

3. The nonwoven fibrous structure of claim 1 comprising a plurality of compressed sites that form at least one line of weakness.

4. The nonwoven fibrous structure of claim 3 wherein said fibrous structure at least partially fails along said line of weakness.

5. The nonwoven fibrous structure of claim 3 wherein said at least one line of weakness is linearly continuous from edge-to-edge of said fibrous structure.

6. The nonwoven fibrous structure of claim 1 comprising discrete uncompressed regions, wherein said discrete uncompressed regions have an elongation at maximum force in the machine direction and an elongation at maximum force in the cross direction.

7. The nonwoven fibrous structure of claim 1 comprising discrete uncompressed regions, wherein said discrete uncompressed regions have a tensile strength in the machine direction and a tensile strength in the cross direction.

8. The nonwoven fibrous structure of claim 1 comprising a plurality of compressed sites wherein said plurality of compressed sites are arranged to form a pattern.

9. The nonwoven fibrous structure of claim 8 wherein said pattern is a geometric shape.

10. The nonwoven fibrous structure of claim 9 wherein said molded element comprises a size-radius and said size-radius is larger than a size of said geometric shape.

11. The nonwoven fibrous structure of claim 9 wherein said molded element comprises a size-radius and said size-radius is smaller than a size of said geometric shape.

12. The nonwoven fibrous structure of claim 9 wherein said molded element comprises a size-radius and said size-radius is similar to a size of said geometric shape.

13. The nonwoven fibrous structure of claim 1 wherein said molded element is hollow.

14. The nonwoven fibrous structure of claim 1 wherein said molded element is made via hydromolding.

15. The nonwoven fibrous structure of claim 1 wherein said fibrous structure further comprises a binder.

16. A substrate comprising said nonwoven fibrous structure of claim 1.

17. The substrate of claim 16 associated with a composition.

18. A process for making a nonwoven fibrous structure comprising at least one compressed site and at least one molded element comprising the steps of:
a. conveying a fibrous web along a machine direction over a molding member, wherein said molding member comprises a pattern of raised areas, lowered areas, or combinations thereof;
b. hydromolding said fibrous web, wherein said fibrous web conforms in correspondence with said pattern to form a molded element; and
c. imparting a compressive stress to said fibrous web.

19. The process of claim 18 wherein said compressive stress is applied subsequent to said hydromolding.

20. A fibrous structure made according to the process of claim 18.
